(19) United States
(12) Patent Application Publication
(10) Pub. No.: US 2011/0221900 A1
(43) Pub. Date: Sep. 15, 2011

(54) DEVICE AND METHOD FOR THE POSITION STABILIZATION OF CAMERAS, AND FOR PRODUCING FILM RECORDINGS FROM UNMANNED AIRCRAFT

(76) Inventor: Stefan Reich, Murnau (DE)

(21) Appl. No.: 13/059,639

(22) PCT Filed: Aug. 25, 2009
(86) PCT No.: PCT/EP2009/006151

§ 371 Date: May 12, 2011

(30) Foreign Application Priority Data
Aug. 25, 2008 (DE) 10 2008 039 468.8

(51) Int. Cl. H04N 5/232; H04N 7/18

(52) U.S. Cl. 348/144; 348/208.2; 348/148; 348/E05.046; 348/E07.085

(57) ABSTRACT

The invention relates to a device and a method for the stabilization of the position of cameras, and for the production of film recordings from unmanned airborne objects

An position stabilization system for a camera suspended in a motor-driven pivot device so as to be able to pivot the same about multiple axes, comprising rotary sensors or angular rate sensors and a closed-loop control, wherein the assignment, the coupling degree, and/or the effective direction of the signals in the control path from the angular rate sensors to the motors can be variably controlled by means of a cross-fade circuit as a function of the relative orientation of the measured rotational axes to the driven rotational axes. The invention further relates to special mechanical embodiments of the pivot device.

The invention relates to a position stabilizing system for cameras and other imaging sensors or other payloads, the exact alignment of which is critical. A stabilization of the alignment is critical in particular on moving camera supports, such as vehicles, airborne objects, and camera cranes, in order to achieve the best possible results in film or video recordings.

Conventional precision devices for supporting cameras include a pivoting platform, as well as servomotors resetting any deviations of the alignment to a target value via a closed-loop circuit.

DE 195 99 41 A describes a stabilizing platform for the fixed mounting of a camera tripod or the like, including a gyroscope and potentiometers connected to the same, and wherein torque adjusters are utilized for aligning the camera.

EP 1 061 338 A1 describes a device for the stabilization of the spacial orientation of sensors, wherein a sensor platform is mounted as a gravity pendulum such that the same is located in a weakly stable, nearly indifferent equilibrium. In particular, the mount proposed is a gimbal joint or a ball joint, or a gimbal mount embodied as an exterior frame system. Furthermore, torque sensors are provided in particular as the drive, and angle sensors are provided in particular for measuring the relative position with respect to the vehicle. Further, paragraphs [0041] and [0043] therein describe that the torque sensors may be constructed of a combination of position sensors and elastic coupling elements.

WO 2004/067432 A2 describes a suspension (gimbal suspension) which can be gimbal swiveled into multiple axes, wherein quickly acting servomotors are provided for balancing vibrations and slowly acting servomotors of various orientations of axes for pivoting the camera. Thereby a “gimbal lock” can be avoided, i.e. the situation, wherein during a tilting of the camera, two axes come to rest parallel, due to which a degree-of-freedom of the gimbal suspension would be lost, and the same would not be able to follow a movement into the respective direction. One disadvantage of said device is the large amount of redundant axes and related servomotors required.

U.S. Pat. No. 6,154,317 A describes a camera suspension having multiple gimbal joints that are nested, wherein gyro-angular rate sensors are mounted on various locations of the device in order to measure the respective rotation. For this purpose, one of said sensors is mounted such that the same follows all movements of the camera. One disadvantage is that not all movement axes are measured directly on the camera, but instead parts of the gimbal are located between the camera and some of the measuring sensors, thus having an adverse effect on accuracy.

U.S. Pat. No. 5,897,223 A describes a spring-dampened and stabilized platform, wherein angular rate sensors follow the movements of the camera. However, the mechanical driving required is expensive.

All above mentioned devices have the disadvantage that high expenses are required. Furthermore, if quick movements, agitations, or vibrations are to be equalized, the servomotors or sensors, as well as the regulation thereof, must achieve an extremely high reaction speed in order eliminate the agitations of the surroundings and such that no regulating delays occur.

The object of the invention is to provide a cost-effective and efficient system, as well as a method for the position stabilization of cameras, by means of which quick agitations and vibrations may also be equalized.

For this purpose the characteristics stated in the independent claims are provided.

The term camera includes imaging sensors of any type. The camera and any possible following devices are also denoted as payload in the following.

The motors are provided for driving the rotational movements occurring about the rotational axes. The term motor, servo, or drive includes any type of actuator, guidance, or drive. According to the invention both the desired pivoting of the camera and the active equalization of the movements of the surroundings may occur, wherein the surroundings move, and the camera is held stationary by means of the device.

According to a first aspect of the invention, in the position stabilizing device, the camera is connected by a suspension to the surroundings, particularly to a vehicle, in a rotatable manner about at least two rotational axes. Furthermore, motors are provided for driving the rotational movements occurring about the rotational axis. Further characteristics of the device are as follows:

angular rate sensors for multiples of the rotational axes are provided on the camera, or on a platform provided for receiving the camera such that the same move conjointly and the rotational movements thereof are identical to those of the camera,

a closed-loop control system is provided, comprising the angular rate sensors and a regulating circuit connected to the same, which actuate the motors, and

a cross-fade circuit variably controlling the assignment, the coupling degree, and/or the effective direction of the signals on the signal path from the angular rate sensors to the motors as a function of the relative orientation of the rotational axes on the basis of a measured or approximated signal rendering or approximating the relative orientation of the rotational axes to each other.

According to a second aspect of the invention, a device is provided for the position stabilization of a camera, having a mount which can be rotated about at least two rotational axes, and by means of which the camera can be connected to the surroundings, particularly a vehicle. The device further comprises motors for driving the rotational movements occurring about the rotational axes, as well as stabilizing electronics including rotation sensors attached to the mount such that the same follow all movements of the camera. The stabilizing electronics actuates the motors and is embodied such that the same variably control the assignment, coupling degree, and/or the effective direction of the signals in the signal path from the sensors to the motors as a function of the relative orientation of the rotational axes among each other.

Further within the device, signals of the rotational sensors may preferably reach the regulating circuit of the stabilizing electronics, which forms control point signals from the signals, and emits the same to the motors. For this purpose, signals on the signal path may be variably mixed from the rotational sensors to the motors among signals belonging to various rotational axes, wherein the coefficients of the mixture are each controlled by one signal rendering the relative orientation between driving and measuring axis directions.

Electronic gyroscopes may be utilized as angular rate sensors. A yielding coupling link may be provided at one location in the drive path or actuation path of the motor. This may be realized, for example, with an elastic connection. The same may be provided between the motor shaft and the output, or between the motor housing and the counter-side of the drive, i.e. the contact point or surroundings of the motor. In general the same may be provided at any location in the drive path or actuation path of the motor.

In particular, the motor housing may, for example, be freely suspended, wherein the motor is attached to the surroundings thereof, for example, on its shaft only, and additionally via a spring.

The sides of the actuation are also arbitrary, i.e. the side of the motor housing may be assigned to the side of the camera or of the vehicle.

The device mechanically connects a camera to a vehicle, or to other supporting surroundings. The pivoting mount may represent a connection between a platform provided for receiving the camera, together with a connecting body provided for assembly to the surroundings or a vehicle. The term platform includes any body that is suitable for attachment.

In the following description the term vehicle includes any supporting surroundings, e.g. particularly an airborne object, a camera crane, another object, or a camera man carrying the device. The invention may be provided in unmanned airborne objects, particularly in model helicopters, quadrocopters, or similar hovering airborne objects that are remotely controlled from the ground.

Any drive device that can be regulated may be utilized as the motor, particularly electric motors or electric magnets, which are capable of driving in one direction, or a counter-direction, particularly in a linear and/or rotational manner. A bearing that can be simultaneously pivoted about multiple axes, or a cardan arrangement of multiple bearings or joints may serve as the pivot bearing.

The invention is based on the knowledge that an improved correction of position may be carried out, if the signals are cross-faded as a function of the relative orientation of the pivot axes such that allowances are made for a changed sense of direction of the action of individual motors resulting from changed orientations of axis.

This further enables the advantage that manual commands as to the camera target movement can be carried out such that the same always match the current camera orientation, i.e., that the directions are oriented like the monitor image. This may be realized as an option.

The invention may also advantageously achieve that additional movements and vibrations occurring due to bearing clearance and/or oscillations or other mechanical influences, may also be eliminated by means of the closed-loop control, because the measuring sensors of all axes also measure said influences in that the same are attached such that they simultaneously move with the camera. Overall, both intentional movements in all required directions may be brought about, and vibrations and other influences may be eliminated by means of the motors. The same motor may be used for fine and rough movements. The calculative additional expenditure for the electronic closed-loop control is out-weighed by a significantly lower mechanical expenditure.

At least 2 pivot axes may be provided. In order to be able to completely decouple any agitations, 3 pivot axes are of advantage. More than 3 pivot axes may also be provided, which is wise in order to avoid any singularities, with which two axes become parallel at certain inclination angle combinations, and thus the camera would no longer be movable in all directions, if 2 of 3 axes are positioned parallel to each other.

Preferably, the pivot axes are positioned near the center of gravity. This may particularly comprise the fact that the center of gravity of the camera, along with all of its following parts of the related pivot axis, has a distance of less than 10% of the longest dimension of the camera. At least in one mode of operation the rotational movements of the camera should be carried out completely independent of those of the surroundings. In particular, the camera should optionally be stationary, or carry out defined controllable rotations. Rotations may be in particular swivel, pitch, or roll movements. For this purpose, any influencing or stabilization of translation movements are not necessarily included. However, as is common in camera suspensions, the entire frame may be suspended in a soft resilient manner in order to additional decouple any vibrations to the largest extent possible. The linkage may be intentionally softened by means of a yielding, particularly elastic coupling device. An elastic material may serve as the coupling element, such as a spring, particularly a spiral spring or torsion spring, a rubber or foam part, a transmission by means of a belt pulley, and a belt that can be stretched in elongated direction, or the like.

Advantageously, temporary or quick errors may be prevented much better by means of the invention. The same is true both for the movements of the surroundings and for measuring fluctuations of the stabilizing device, and for any irregularities or vibrations during the operation of the motors. Furthermore, a substantially quicker balance is possible despite of a significantly lower requirement of the quickness of the sensors, and particularly of the actuating elements.

In a preferred embodiment of the invention the resonance frequency resulting from the elastic suspension and the mass (moment of inertia) of the pivoting parts is configured lower than the plurality of the incident interfering movements.

In addition, or alternatively, said resonance frequency may be configured much lower than the velocity of a provided closed-loop control. In this manner a high regulating amplification is possible, wherein particularly the closed-loop control is embodied by means of a suitable adjustment of the parameters thereof such that the same may overcome the resulting additional mechanical 90° phase lag. This is possible, for example, via means known from a PID closed-loop control. If the camera is to carry out intentional movements, the same are limited with respect to the maximal possible acceleration thereof. However, this does not constitute a disadvantage, because the target values of the camera orientation are normally changed as steadily and slowly as possible to begin with.

A further advantage of the invention is that in order to achieve this quality, no costly torque sensors, or particularly quickly acting actuator elements of any other type must be utilized.

The term motor includes any type of electromechanical actuating element. In particular, commercially available servomotors may be advantageously used. Such servos are constructed as position actuators, and may include the following structurally conjoined components: a motor, a gear reduction between the motor and an output shaft, a position sensor on the output shaft, such as a rotational potentiometer, and an electronic regulating actuation unit, which compares a target value input signal to the measured value of the position sensor, and actuates the motor.

A further embodiment of the present invention provides that with the use of a commercially available servo, the position sensor thereof is removed, or at least separated from the regulating electronics thereof, and that said regulating electronics are connected to a sensor measuring the differential movements occurring at the yielding coupling. In this way it is achieved that the already contained regulating electronics track the motor such that the same sets the link provided for the yielding coupling to a differential movement predetermined by the target value. When using an elastic body as the coupling element, a defined mechanical tension is thereby created. In special cases the same may correspond to a defined torque. In general a sensor may be provided for measuring a differential movement occurring at the yielding coupling, and the measured value thereof may be drawn upon via a regulating circuit for controlling the motor.

Preferred exemplary embodiments of the invention are described based on the figures, as follows:

They show:

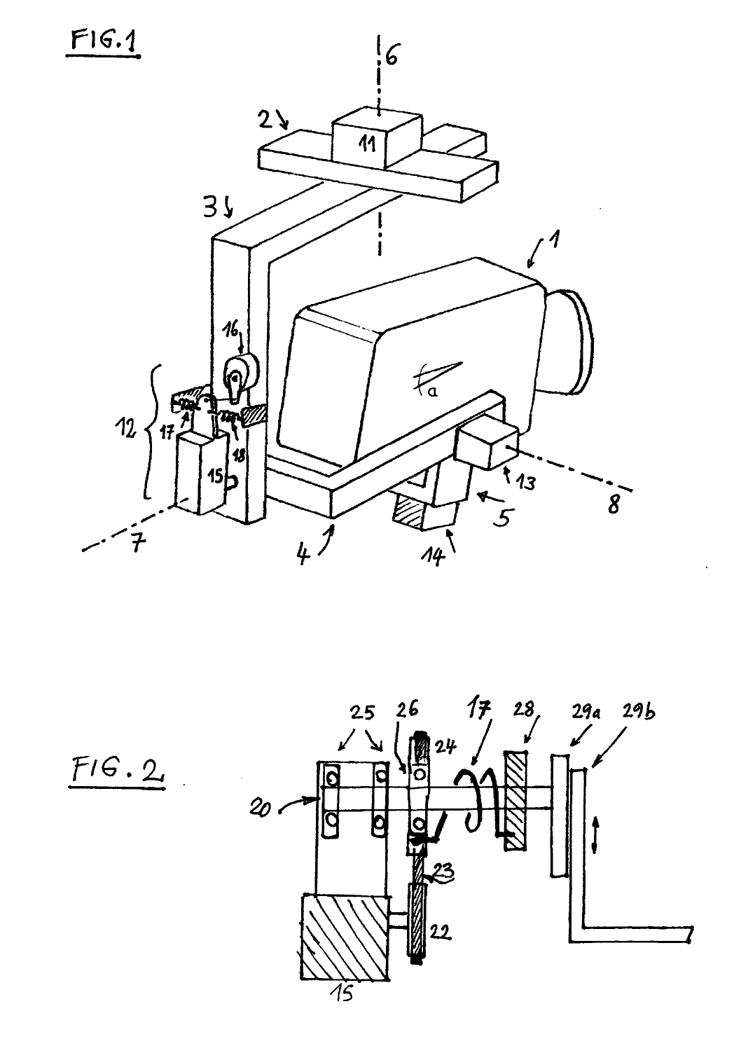

FIG. 1: a device for the stabilization of the position of a camera,

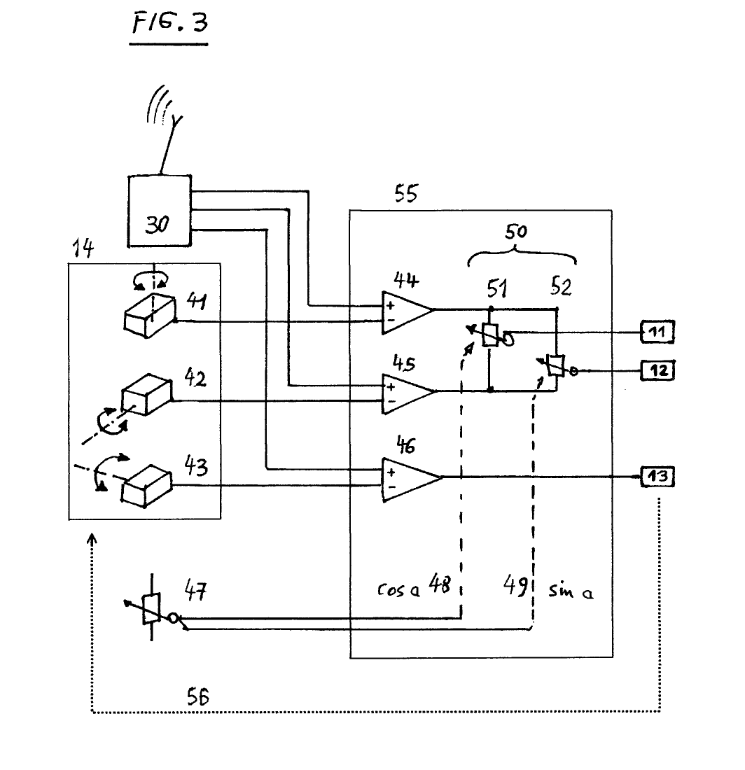

FIG. 2: a cross-section for elements of an elastic coupling,

FIG. 3: a block diagram of an position closed-loop control, and

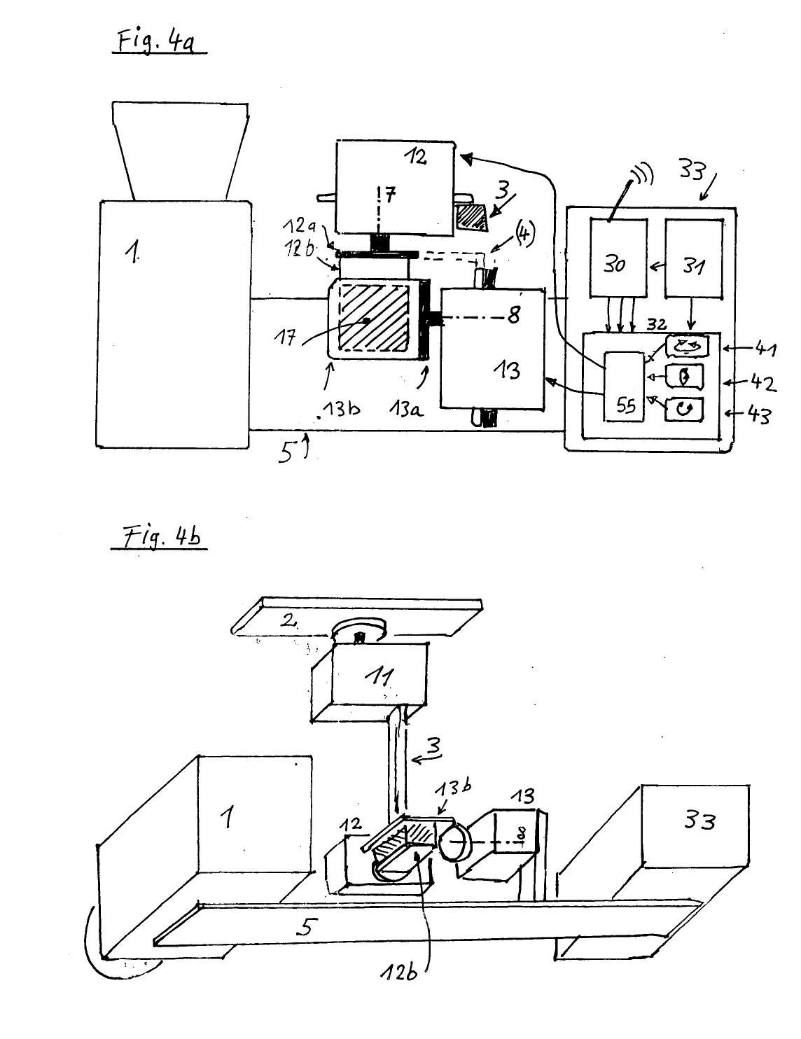

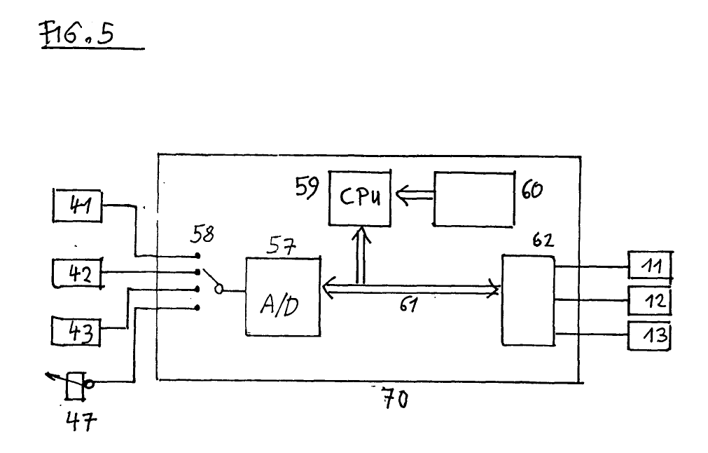

FIGS. 4a and 4b: a further device for the stabilization of the position of a camera,

FIG. 5: a block diagram of a digitally operating position closed-loop control.

In the figures the same reference symbols are used for components corresponding to each other.

FIG. 1 shows the mechanism of a first exemplary embodiment. The surroundings part 2 is provided for the stationary or spring-loaded attachment to the surroundings, particularly to a vehicle. The same essentially follows the movement of the surroundings and is therefore also considered as an integral part of the surroundings in the following description. A frame embodied as a cardan frame consists of three angled sections or journals 3, 4, and 5 that are movable across three pivot axes 6, 7, 8. The last section 5 thereof is provided for carrying the camera 1.

A drive unit 12 is provided for driving the same about the pivot axes 7. The same includes a servomotor 15 with integrated gears 4, the drive shaft of which is connected to the frame section 5. In order to achieve a yielding coupling the motor 15 is not firmly connected to the other frame section 3 thereof, but is freely suspended for the output shaft thereof. Only the spiral springs 17 and 18 represent a power connection between the frame section 3 and the motor 15, thus serving as a yielding coupling in the transmission path.

The regulating and actuating unit actuating the servomotor 15, which may already be contained in a commercially available servo, may be connected to a position sensor or potentiometer 16 that is articulated such that the same measures the differential movement, which also follow the springs 17 and 18.

The same may also be provided for the other pivot axes 6 and 8 in their associated drive units 11 and 13.

Any temporary interferences, as may occur as a torque by means of agitation and vibrations, are directly decoupled from the vehicle or the surroundings by means of the yielding coupling in interaction with the moment of inertia of the payload, even if the same arbitrarily occur in quicker succession that the motors and the closed-loop control reacts. Any interferences lasting longer are additionally equalized by the closed-loop control via the motor.

FIG. 2 shows a detailed view of another embodiment of the yielding coupling at a cross-section. The figure illustrates parts of a drive unit that may be utilized, for example as a drive unit 13 and 11 in FIG. 1. The motor 15 drives a second belt pulley 24 via a belt pulley 22 and a belt 23, which runs on the drive shaft 2 in a pivoting manner via a ball bearing 26. The output shaft 2 may also be pivoted via ball bearings 25. The coupling of the second belt pulley 24 to the output shaft 20 is carried out only via a spring 17 transferring torsion forces and serving as a yielding coupling. Said coupling is carried out between the belt pulley 26 and an actuating ring 28. FIG. 2 further shows a possibility for balancing out the center of gravity on the rotational axis. The platform 29b serving as a camera receiver, and a rail 29a attached on the output shaft 20, may be displaced against each other and fixed as carriages.

The axis arrangement illustrated in FIG. 1 makes it possible that no mechanical “gimbal lock” occurs, even with a camera pointing toward the bottom, but that the camera remains freely movable in all directions, instead. The axis 6 is a pan axis actuated by the pan motor unit 11. The axis 7 is a roll axis mechanically positioned behind the pan axis when beginning from the exterior, and when actuated by the roll motor unit 12. The axis 8 is a pitch axis mechanically assigned closest to the camera, and actuated by the pitch motor unit 13.

In the present exemplary embodiment a regulating of the position is provided, wherein the sensors 14 or the sensor unit 14 follow the movements of the camera 1 for the detection of position. In particular, said sensors may be angular rate sensors. The control value of this regulating of the position may be drawn on as the target value of the closed-loop control on the motor side.

Position sensors may be conjointly arranged for all three rotational axes 6, 7, 8 such that the same simultaneously rotate with the camera about all axes. This may mean in particular that the same are not present separately at individual or upstream sections of the cardan joint. If the camera 1, as illustrated in FIG. 1, is aligned horizontally, or is pivoted by only a small angle, the rotational axes 6, 7, 8 of the motor units 11, 12, 13 also correspond to the movements based on the camera 1, and to the rotational sensors 41, 42, 32 of FIG. 3 that are located in the sensor unit 14. In this case it is possible without any provisions to apply a dedicated regulating circuit to each of the three sensor signals, which in turn forms a closed-loop circuit (closed-loop control) by means of actuating the motor 11, 12, 13 as the actuating element, which is assigned to the respective axis, wherein each closed-loop circuit may stabilize the orientation of the camera 1 in the respective axis.

It may occur in the conjoined sensor arrangement that the orientation of individual mechanical rotational axes is not necessarily constant, but changes by means of the rotation about one of the other axes with respect to the sensor unit 14. For example, a rotation about the pivot axis (pan axis) 6 in the camera 1, as well as of the sensor unit 14 is no longer detected as a pan movement, but as a roll movement, if the camera is not pointed toward the front as illustrated, but is pointed toward the bottom about the pitch axis 8.

With an inclined camera 1, the roll axis 7 particularly acts as a lateral pivot axis with respect to the camera 1 (camera scan axis); and the pan axis 6 acts as a roll axis, with respect to the camera 1. In case of intermediate conditions, such as “camera inclined at an angle front bottom”, mixed movement forms occur accordingly. Therefore, if the camera orientation is changed from the pictured orientation at stronger angles, the orientation of the axes changes relative to each other. In particular, the orientation of the axes of the motors relative to the axes of the rotational sensors and the camera changes, and thus the effective direction of the servomotors, based on camera and sensors, is also changed. With the prior art (e.g. U.S. Pat. No. 6,154,317 A), the sensor of all of the axes are not located on the camera, but are distributed to such locations of the cardan device, at which the movements can always be assigned to the respective motors.

In order to enable a regulating of position regardless of the orientation, if angular rate sensors for multiple rotational axes conjointly follow the same movements as the camera, as described, in that all are attached at the part on the side of the camera, the present exemplary embodiments provide that the relative orientation of the rotational axes to each other is measured or approximated directly or indirectly, and that the assignment, coupling degree, and/or effective direction of the signals on the signal path from the angular rate sensors to the motors is variably controlled as a function of the relative orientation of the rotational axes.

The relative orientation of the roll axis assigned to the sensor 42, and of the pan axis assigned to the sensor 41 relative to the motor axis 7 (roll) may be measured in the exemplary embodiments, in that the angle of inclination a occurring in the pitch axis 8 is measured. The relative orientation of the axes assigned to the sensors relative to the motor axes 6 (pan) can be measured by measuring both the angle of inclination a and the roll angle b occurring in the motor axis 7 (roll).

The variable control may be carried out as a cross-fading or a mixture with variable coefficients, wherein the coefficients are controlled as a function of the relative orientation of the rotational axes. The variation may be carried out in any fine steps, or quasi-continuously, or may be approximated by means of a discrete number of steps, wherein, however, a plurality of steps, and accordingly a plurality of possible mixing factors, is always provided.

There are various possibilities of measured values for the relative orientation of the axes to the camera. An incline measured from an artificial horizon may be used, particularly, if an approximately horizontal alignment of the surroundings may be assumed. Alternatively, or additionally, rotational position sensors, such as potentiometers or angle sensors, may be used at the rotational axes 7 and 8.

Furthermore, the control value may be utilized as the approximation, by means of which the motors 13 (pitch) and 14 (roll) are to be actuated, particularly, if the same are position-actuating servos. The cross-fading of the signals within the regulating circuit may be carried out in a manner controlled by said measured values.

The regulating of the position may be carried out via measured angular rates. Alternatively, or additionally, the regulating of the position may also be carried out, in that measured values of angles of inclination are used. Optionally angular rate values, or angle values, or a combination of both, may be provided as the target values of the camera alignment.

An artificial horizon may be provided as the sensor for regulating the position, comprising three angular rate sensors and one acceleration sensor measuring the direction of gravity.

FIG. 3 shows a block diagram of an exemplary embodiment of a position closed-loop control. Angular rate sensors 41, 42, 32 are attached on the camera, wherein the sensor 41 is aligned to a pivoting axis (pan or yaw movement), 42 is aligned to a roll axis, and 43 is aligned to a pitch axis, and said alignment always refers to the camera. Electronic gyroscopes may serve as the angular rate sensors. Target values are received via a radio receiver 30, which correspond to the desired angular rate of the camera movement in said axes, and are zero in special cases of a standstill. The regulating amplifiers 44, 45, and 46 may be conventional operation amplifiers, or PID (proportional differential integral) regulators. Each contains a difference former for forming a actual value/target value difference from the respective target values received from the radio receiver 30, and the actual values measured by the assigned angular rate sensors 41, 42, 43. Optionally, the same comprise an integrator, by means of which the actual/target value difference can be integrated. The output values are used as control values for actuating the assigned drive units 11, 12, 13. Said drive units may be identical to the motors shown in FIG. 1. A control loop is closed via the mechanical effect (56) of the motors on the platform, and thus the sensors. The regulating function may be called a degenerative feedback. The regulating circuit may be constructed as a regulating unit 55, and may optionally also be structurally combined with the sensors 41, 42, 43 of the sensor unit 14.

A sensor 47 is provided for measuring an angle of inclination a of the cardan suspension about the pitch axis 8 thereof. For this purpose, for example, a potentiometer may be attached to said axis, and/or an acceleration sensor may be housed in the sensor unit 14, which estimates the incline based on gravitation. The inclination measuring signal is rendered as a cosine value 48 and as a sine value 49 of the angle of inclination a, or is converted. The cross-fading circuit 50 changes the assignment of the control values of the regulators 44, 45 to the drive units 11, 12. The cross-fading may be defined as a mixture having variable coefficients, wherein the coefficients are defined by the angle of inclination a, or generally by a signal reporting the axis assignment. The variation may, for example, consist of a potentiometer as illustrated, or of a mixer element having variable amplification factors. The cosine value 48 controls those portions, which the motor unit 11 receives from the regulators 44 and 45, wherein cross-fading is carried out between said values as a function of the cosine value 48. For this purpose the part of the cross-fading circuit 50 illustrated as a potentiometer 51 is provided. Accordingly, a cross-fading of the control value provided for the drive unit 12 is carried out in a converse manner in the part of the cross-fading circuit 50 illustrated as the potentiometer 52, which is controlled by the sine value 49.

As described below, said cross-fading corresponds to the variable effects of the rotational movements that can be created in the drive units, (said effects) resulting from the multi-dimensional changing axis orientations as a function of the orientation of the rotational axes to each other: with a horizontal orientation of the camera 1, wherein the angle of inclination and the sine thereof has a value of zero, and the cosine thereof has the value of 1, the regulating unit 44 is assigned to the motor unit 11, and the regulating unit 45 is assigned to the motor unit 12. Thus, the angular rate sensor 41 measuring the pivot (pan) movement controls the vertical axis drive unit 11, thereby stabilizing the rotational position thereof, and the angular rate sensor 42 measuring the roll movement controls the roll axis drive unit 12. With a vertical orientation of the camera 1 the assignment is interchanged; the angular rate sensor 42 measuring the roll movement controls the drive unit 11; the same drives the roll movement thereof while the camera is pointed toward the bottom such that as a result the roll movement is correctly stabilized. With a mean camera orientation, such as front bottom, the assignment is continuously cross-faded as a function of the angle. The cross-fading may be realized as a mixture having variable coefficients. The coefficients may be sine and cosine values of the rotation. Negative coefficients may also be included, thus reversing the effective direction of the closed loop control described. For example, with a camera orientation bottom rear the action of the motor unit 11 acts in counter-direction on the pivot movement on the camera side; accordingly, the effective direction of the pan angular rate sensor 41 may inversely be coupled to the motor unit 11 by means of a negative coefficient.

Similar may be provided with a sensor for the roll axis 7 for measuring a roll angle b for the further cross-fading of measuring values to control values. For example, with an increasing roll angle the influence of the vertical axis motor 11 will transition to the pitch measurement, and correspondingly, the pitch angular rate sensor is used for actuating the vertical axis motor 11. A matrix may be provided, comprising the signal paths of the closed-loop control of all three axes.

The mixture or cross-fading may generally be provided for the measured signals of the angular rates and/or to the control values, or at every point on the signal path between the sensor and the motor unit. The type of closed-loop control known as PID may be realized by means of inserting the respective known components. The control of the coefficients may be carried out as a function of the axis orientation, such as by means of a measured roll and pitch angle. The mixture may be carried out as a vectorial rotation; the mixing coefficients may correspond to a rotation matrix.

In special cases of the cardan arrangement illustrated in FIG. 1 or 4, suitable coefficients may be rendered from the measured pitch angle a and roll angle b, for example, according to the following matrix:

| from | lateral scan | roll | pitch | . . . to |
|---|---|---|---|---|
| sensor | (pan) (41) | (42) | (43) | motor |

| | | | |
|---|---|---|---|
| cos(a) | −sin(a) | sin (b) | pan (11) |
| sin(a) | cos(a) | 0 | roll (12) |
| 0 | 0 | 1 | pitch (13) |

The results contained in the right column may be calculated as the sum of the remaining columns, and fed to the respective motor as the control point signal. In writing, the matrix provides the following:

Control point signal (pan)=Sensor signal (pan)·cos(a)−sensor signal (roll)·sin(a)−sensor signal (pitch)·sin(b)

and accordingly for both of the other matrix lines of the control point signals roll and pitch.

A measured value of a rotational potentiometer attached to the pitch axis 8 between the two journals 4 and 5 may be used as the value a. The measured value of a rotation potentiometer attached to the roll axis 7 between the two journals 3 and 4 may be used as the value b.

The following matrix additionally takes into consideration the influences of the rotational angle b measured about the roll axis to the assignment of the pan and roll drive.

| from | lateral scan | roll | pitch | . . . to |
|---|---|---|---|---|
| sensor | (pan) (41) | (42) | (43) | motor |
| | cos(a) · cos(b) | −sin(a) · cos(b) | sin(b) | pan (11) |
| | sin(a) · cos(b) | cos(a) | 0 | roll (12) |
| | 0 | 0 | 1 | pitch (13) |

The signal actions described may be carried out analogously or digitally, and particularly as program-controlled steps on a digital controller or microprocessor. In particular, the signals of the sensors 41, 42, 43 may be forwarded to an AD converter, and the signal values created from the same may be numerically calculated in the subsequent steps, particularly in a software-controlled manner.

FIG. 5 shows an exemplary embodiment of a digitally operating regulating unit 32 in a block diagram. The microcontroller 70 comprises an AD converter 57 and a multiplex switch 58, which cyclically connects the signals of the angular rate sensors 41, 42, 43, and of the sensor 47 to the AD converter 57 in a program-controlled manner. The digital measured values generated by the AD converter 57 may be sent to the CPU 59 via the data bus 61, and processed there in terms of cyclic calculation in accordance with the signal flow described in FIG. 3. The calculated control values may be supplied to the motors 11, 12, 13 via an output port 62. The steps and process steps described may be controlled by means of the code stored in the program memory 60.

In particular, the regulating amplifiers 44, 45, 46 may be implemented on the CPU (central processing unit, 59) of the controller as subtractions between predetermined target values and the signal values (actual values). Instead of the cross-fading/mixing devices pictured as potentiometers 51, 52, arithmetic operations, such as multiplications and additions to the signal values may occur in the CPU of the controller, or of the microprocessor, respectively.

Their multiplication factors may be calculated, for example, as cos (a) in the upper branch, and 1−cos (a) in the lower branch for the cross-fading link 51, and as sin (a) in the upper branch and 1−sin (a) in the lower branch for the cross-fading link 52, or as an alternative the coefficients from one of the remaining matrices may be used for a more accurate calculation, and the actuating values (control values) may be generated from the same.

The digital controller may comprise additional components, such as input and output interfaces, for example, for the signals, actuating values and/or the loading of the calculation software, as well as the setting of the calculation coefficient, a display unit, a bus system, memory elements for storing the calculation software, and/or other control programs.

Furthermore, a measured value of a roll inclination of the camera, derived from the artificial horizon, may be used for the additional correction of the roll inclination of the camera, particularly for the automatic neutralization of the same. For this purpose an additional closed-loop circuit may be formed, wherein the measured value of the roll inclination is supplied to a control value in a degenerative feedback manner, for example, in that the measured value is mixed in addition to the measured value of the camera roll rate gained from the sensor 42. The mixing factor may be provided at such a slight manner such that said correction is carried out using a slower time response than the remaining regulating of the position.

An electronic device of the type described may also be provided separately from the cardan mechanism for the purpose of a retrofitting assembly.

FIGS. 4a and 4b show an additional mechanical embodiment of the invention, wherein FIG. 4a illustrates a top view, and 4b illustrates a view of the same device. The platform 5 carries the camera 1 on its one side, and an electronic unit 33 on its opposite side, comprised of a power supply 31, radio receiver 30, and position regulating unit 32, which in turn includes the angular rate sensors 41, 42, and 32 and may be constructed according to FIG. 3. Furthermore, the servo 13 provided for the pitch movement is also attached on the platform. A spring element or damping element 17, made from foam having elastic and damping properties, is arranged between a lower plate 12b and an upper plate 13b, wherein the upper plate is attached to the mechanical outlet 13a of the pitch servo, and the lower plate 12b is attached on the mechanical outlet (control lever) 12a of a roll servo 12. The foam between the plates is attached at a position at which the mutual spatial center of gravity is located of all parts of the device following the platform 5.

Optionally, a servo 11 provided for the pan (yaw) movement may additionally be provided; the housing of which may be connected to the rest of the device, for example, on a roll servo 12, via an arm 3, and rotates the same. In another embodiment the roll servo 12 may optionally be omitted.

The spring link or damping element 17 is located serially in the mechanical transmission path between the surroundings and the camera. It may yield in all 6 degrees of freedom, i.e. in all rotational movements of the 3 spatial axes and in all 3 translation axes. If the soft coupling is targeted for rotational movements, the spatial position of the elastic link is insignificant, because the elasticity thereof may be mechanically coupled, for example, via axes, levers, etc. Furthermore, however, translation movements are also simultaneously coupled or spring-loaded, respectively, via the same soft coupling element. The advantage is that with abrupt movements and vibrations not only the rotating components, but also particularly the translational components may be absorbed and decoupled. So that no additional rotational movements are induced, as would be the case, if such damping or absorption would be located outside of the center of gravity, it is of advantage, if the spring-loaded part or the damping element is located in the center of gravity as accurately as possible, or in the case of multiple spring-loaded parts, if the total effect of the absorption is located in the center of gravity as accurately as possible. A suitable damping element may, for example, consist of foam having a cubical or cylindrical shape. Furthermore, said damping link makes it possible that a position regulation that is adjusted to the same may better suppress and regulate temporary or quick interferences than with a conventional, hard coupling.

In the example illustrated the pitch servo 13 is provided in a fixed manner on the movable platform 5 as the only servo; while the damping element 17 is incorporated on the transmission path more toward the “front”, i.e. in the direction of the surroundings. As an alternative, said servo 13 may also be provided on the transmission path “before” the damping element 17. For this purpose the same may be attached to the mechanical outlet (control lever) of the roll servo 12 via an arm 4 illustrated as a dotted line, and the upper plate 13b of the damping element 17 may not be attached on the outlet of the roll servo 12, but instead on the platform 5.

It is also possible that the mechanical relevant coupling path between the surroundings and the camera exclusively extends through the damping element (17), i.e. no further parallel coupling link exists on this coupling path.

In an advantageous embodiment it is possible to use commercially available servos as motors. It is further possible to exclusively use the existing axis bearings, thus carrying the payload together with the camera such that no additional bearings need to be provided.

Without a measuring and regulating device provided for the position of the camera, a spring-loaded supporting of the camera would lead to uncontrollable rocking motions. Together with the position stabilizing closed-loop control described, however, a much improved smoothness is achieved than with direct coupling without any suspension. The mass of the camera is utilized for damping in a similar manner as in the hand-held system known as a “steadycam.”

Contrary to a hard linkage, however, a delayed reaction between the action of the actuating element and the result within the measured value is obtained for the regulation of the position. This may commonly lead to problems involving regulating oscillations. Usually, a weaker adjusted regulating amplification than with a rigid mechanism would be accepted in order to avoid this. However, according to the invention said problem may also be avoided by means of a suitable adjustment of the regulating parameters. A suitable adjustment may contain highly increased portions in the differential branch of the closed-loop control. With a suitable adjustment a significant advantage may be achieved with the characteristics resulting overall from a softer mechanical linkage and simultaneously harder electronic linkage. Advantageously, temporary or quick interferences are prevented much better; this applies both to the movements of the surroundings and to any measurement fluctuations of the stabilizing device, as well as to any irregularities or vibrations in the operation of the motors. Furthermore, with the significantly lower requirement to the quickness of the sensors, and particularly to the actuating elements, a significantly quicker balance is still possible. In a preferred embodiment of the invention the resonance frequency resulting from an elastic suspension and the mass (moment of inertia) of the pivoting parts, is lower than the plurality of the interfering movements occurring.

1-22. (canceled)

23. An electronic device for the stabilization of the position of a camera being rotatable suspended on a suspension comprising multiple rotational suspension axes and comprising motors for driving the rotational movements carried out about the rotational suspension axes, comprising:
angular rate sensors for multiple camera-related rotational axes which may be attached to the camera or to a platform such that the sensors move conjointly, and their rotational movements are identical to those of the camera,
a regulating circuit which, based on signals of the angular rate sensors, actuates the motors in such a manner that a closed-loop control circuit can be created,
a cross-fade circuit, based on a measured or approximated signal rendering or approximating the relative orientation of the rotational axes to each other, variably controlling the assignment, the coupling degree, or the effective direction of the signals on the signal path from the angular rate sensors to the motors, as a function of the relative orientation of the rotational axes.

24. A device for the stabilization of the position of a camera, comprising an electronic device of claim 23 and wherein the camera is by means of a suspension, connected in a rotatable manner to the surroundings, in particular to a vehicle, and wherein motors are provided for driving the rotational movements about the rotational axes, and wherein the angular rate sensors are attached on the camera or on a platform provided for receiving the camera, and wherein the rotational axes are arranged in proximity of the center of gravity of the camera along with the parts of the device following along.

25. The device according to claim 23, characterized in that a control point signal emitted for a motor is used for determining the relative orientation of the rotational axes to each other.

26. The device according to claim 23, with a sensor arrangement of an artificial horizon following the rotational movement of the camera and comprising three angular rate sensors, wherein a measured value derived from the artificial horizon is used for determining the relative orientation of the rotational axes to each other.

27. The device according to claim 23, with a sensor arrangement of an artificial horizon following the rotational movement of the camera and comprising three angular rate sensors, wherein a measured inclination value derived from the artificial horizon is used for additional correction of the roll inclination of the camera, in that a closed-loop circuit is formed via degenerative feedback.

28. Device for the stabilization of the position of a camera, comprising a bearing support that is pivotable about two rotational axes and by means of which the camera can be connected to the surroundings, in particular to a vehicle, comprising motors for driving the rotational movements occurring about the rotational axes, and comprising stabilizing electronics comprising rotational sensors,
wherein the rotational axes are arranged in proximity to the center of gravity of the camera along with the respective conjointly moving parts of the device, and comprising a plurality of motors for driving used the rotational movements occurring about the axes, characterized in that a yielding coupling link is provided on the drive path of a motor in the plurality of motors, allowing a differential rotation about axis related to the motor even without the movement of the motor.

29. The device according to claim 28, comprising a part hereinafter referred to as a “platform” for receiving the camera characterized in that parts of the device moving conjointly with the camera are arranged such that a mutual center of gravity of the moved parts is outside of the camera and that in the mutual center of gravity, or acting in the location, a yielding coupling link acting conjointly for multiple rotational axes is provided and incorporated in the mechanical coupling path between platform and the surroundings.

30. The device according to claim 28, characterized in that the yielding coupling link is located in the center of gravity and is incorporated such that the same yields in all six spatial degrees of freedom.

31. The device according to claim 28, characterized in that a motor and gear of a servomotor typically provided as position locator, or particularly of a servo comprising a PPM or PWM input, is used as the motor.

32. Unmanned airborne object, comprising a device according to claim 23.

33. A method for the stabilization of the position of a camera being rotatable suspended about two rotational axes by means of a bearing support and which can be pivoted about the rotational axes by means of motors, comprising the following process steps:
the angular rate of the camera is measured about more than one camera-related rotational axis by means of attaching angular rate sensors to the camera or to a body provided for receiving the camera such that the sensors follow at identical rotational movements;
a closed-loop control circuit is formed, wherein the signals of the angular rate sensors actuate the motors via a regulating circuit connected thereto;
the relative orientation of the rotational axes to each other is measured or represented by means of a signal serving for approximation;
the assignment, coupling degree, or the effective direction of the signals on the signal path from the angular rate sensors to the motors are variably controlled as a function of the relative orientation of the rotational axes.

34. The method according to claim 33, wherein signals on the signal path from the angular rate sensors to the motors are variably mixed among signals belonging to different rotational axes, wherein the coefficients of the mixture are controlled by a signal rendering the relative orientation between the driving and measuring axis direction.

35. The method according to claim 33, wherein the bearing support is cardanically arranged, and wherein coefficients suitable for the variable control are represented and used according to the following matrix using the pitch angle a and the roll angle b measured by a sensor at the bearing support:

| | | | | |
|---|---|---|---|---|
| from | lateral scan | | | . . . to |
| sensor | (pan) | roll | pitch | motor |
| | | | |
|---|---|---|---|
| cos | sin | sin | pan |
| sin | cos | 0 | roll |
| 0 | 0 | 1 | pitch |

36. A method for the production of film recordings from unmanned airborne objects using a camera pivotable about two rotational axes by means of a bearing support which can be pivoted about the rotational axes by means of motors, comprising the following process steps to be accomplished on board of a remotely controllable airborne object:
the angular rate of the camera is measured about more than one camera-related rotational axis by means of attaching angular rate sensors to the camera or to a body provided for receiving the camera such that the sensors follow at identical rotational movements;
a closed-loop control circuit is formed, wherein the signals of the angular rate sensors actuate the motors via a regulating circuit connected thereto;
the relative orientation of the rotational axes to each other is measured or represented by means of a signal serving for approximation;
the assignment, coupling degree, or the effective direction of the signals on the signal path from the angular rate sensors to the motors are variably controlled as a function of the relative orientation of the rotational axes.
